(19) United States
(12) Patent Application Publication
(10) Pub. No.: US 2005/0202830 A1
(43) Pub. Date: Sep. 15, 2005

(54) Method and system for monitoring location of a cellular phone in relation to a predefined geographic area with automatic notation of boundary violations

(76) Inventor: Isaias Sudit, Delray Beach, FL (US)

Correspondence Address: EDWARDS & ANGELL, LLP, P.O. BOX 55874, BOSTON, MA, 02205, US

(21) Appl. No.: 11/067,790

(22) Filed: Feb. 28, 2005

Related U.S. Application Data
(60) Provisional application No. 60/553,239, filed on Mar. 15, 2004.

(51) Int. Cl. H04Q 7/20

(52) U.S. Cl. 455/456.1; 455/456.3

(57) ABSTRACT

A method for monitoring location of a cellular phone in relation to a predefined geographic area with automatic notification of boundary violations is provided. If the cellular phone is carried by a person, the invention can be used to monitor a range of movement of a person carrying the cellular phone. The method can include the steps of selectively identifying a predefined geographic area; monitoring a location of an automatic location identification (ALI) equipped cellular phone; and automatically determining if boundaries of the geographic area have been violated. Notably, the step of determining if the boundaries of the geographic area have been violated can include automatically determining if the location of the cellular phone is within the predefined geographic area. This step can be performed by a remote server or by a cellular phone.

### CROSS-REFERENCE TO RELATED APPLICATIONS

This Application is a Non-Provisional of Provisional (35 USC 119(e)) application 60/553,239 filed on Mar. 15, 2004.

### BACKGROUND OF THE INVENTION

The inventive arrangements relate generally to cellular phones and more particularly to cellular phones with automatic location identification capabilities to determine the position of a user relative to a predefined area.

In June 1996, the Federal Communications Commission (FCC) set in place a two-phase plan for implementing wireless 911 in the United States. Phase I, which was originally to have been implemented by April 1998, required callback numbers and cell site sector information about each incoming wireless 911 call. Cell phones that met the Phase I requirements provided a general indication of the caller's location, although the area may be as large as 100 square miles.

Phase II, which was originally scheduled to have been implemented by October 2001, required wireless carriers to provide automatic location identification (ALI) for each wireless 911 call. The plan included a requirement to provide wireless location accuracy for 95% of the callers within a radius of 150 meters or better. The Phase II portion of the plan was intended to enable improved emergency response in connection with 911 calls. The ALI technology necessary to implement Phase II has been delayed in many instances, but is now being deployed in various locations with the expected improvement in emergency response.

There are two basic methods by which wireless position information can be determined. One approach determines a cell phone position by measuring angle of arrival (AOA) and time of arrival (TOA) of cell phone signals at multiple fixed base stations. This approach is essentially a network-based solution. Still, there are a number of problems associated with such network-based solutions. These problems are mainly related to the vagaries of signal propagation, base station availability and infrastructure costs. An alternative approach makes use of the existing global positioning system (GPS) infrastructure. The GPS based approach incorporates a GPS system into each cell phone and relies upon the phone to determine its location for itself. GPS based systems have their own set of problems that mainly relate to GPS satellite acquisition and cold start delays.

The most advanced ALI systems are those that rely on a combination of both the network based and GPS based solutions. Such systems collect GPS measurements and network measurements and send the measurement data to the position determination entity. The position determination entity then processes the measurements to produce the most accurate location information based on available data.

Currently, ALI technology is commercially available from a number of different technology developers. For example, Qualcomm, Inc. of San Diego, Calif. and SnapTrack, Inc. of Campbell, Calif. offer commercially proven GPS-based positioning solutions for third generation wireless (3G). These systems are available for a variety of different air interfaces including CDMA and GSM. Further, they offer commercially available chipsets that can be integrated in cell phones. Also, rather than requiring modification of each base station, a database is constructed at a position determination entity that contains the precise location of each base station.

Aside from the obvious benefits ALI offers with regard to improving emergency responsiveness, the new technology has also created many opportunities for new and interesting applications that make use of the ALI data. These applications offer revenue-generating products and services that are of potential interest to a range of markets including entertainment, fleet management, and security.

### BRIEF SUMMARY OF THE INVENTION

The invention concerns a method for monitoring location of a cellular phone in relation to a predefined geographic area, with automatic notification of boundary violations. If the cellular phone is carried by a person, the invention can be used to monitor a range of movement of a person carrying the cellular phone. The method can include the steps of selectively identifying a predefined geographic area; monitoring a location of an automatic location identification (ALI) equipped cellular phone; and automatically determining if the boundaries of the geographic area have been violated by crossing the boundary. Notably, the step of determining if the boundaries of the geographic area have been violated can include automatically determining if the location of the cellular phone is within or outside of the predefined geographic area. This step can be performed by a remote server or by a cellular phone.

The method can also include the steps of generating a notification if the location is not within the predefined geographic area and communicating the notification to at least a second person. Conversely, the method can also include the steps of generating a notification if the location is within the boundary. The communicating step can also include communicating the notification to at least a second cellular phone, a web-based application, communicating the notification to at least one email address and/or an instant messaging address.

The step of identifying the predefined geographic area can include one or more additional steps. For example, the additional steps can include selecting a geographic location and a maximum permissible distance from the geographic location.

The step of determining the location of the ALI equipped cellular phone is performed in response to a request from a remote server, in response to a request from a second cellular phone, or it can be determined automatically on a periodic basis by the ALI equipped cellular phone. In any case, the method can include the step of integrating at least one security locking system into the first cellular phone to prevent unauthorized changes to the control settings. In this way, it can be possible to prevent a holder of the first cellular phone from disabling the device in such a way that would prevent its location from being determined in accordance with one of the aforementioned processes.

### BRIEF DESCRIPTION OF THE DRAWINGS

FIG. 1 is a schematic drawing of a cellular automatic location identification (ALI) system in accordance with the invention;

FIG. 2 is a flow chart of the process for determining a violation of a boundary by a cellular phone in accordance with the invention;

FIG. 3 is a front elevation view of a cellular phone having a first screen displayed in accordance with the invention;

FIG. 4 is a front elevation view of a cellular phone having a second screen displayed in accordance with the invention;

FIG. 5 is a front elevation view of a cellular phone having a third screen displayed in accordance with the invention;

FIG. 6 is a front elevation view of a cellular phone having a fourth screen displayed in accordance with the invention;

FIG. 7 is a front elevation view of a cellular phone having a fifth screen displayed in accordance with the invention;

FIG. 8 is a front elevation view of a cellular phone having a sixth screen displayed one in accordance with the invention;

FIG. 9 is a front elevation view of a cellular phone having a seventh screen displayed in accordance with the invention; and

FIG. 10 is a flow chart of the process for determining a boundary violation in accordance with a second embodiment of the invention.

### DETAILED DESCRIPTION OF THE INVENTION

Briefly, the invention concerns a method and apparatus for allowing a control user to monitor and restrict the movement of a monitored cellular phone relative to a predefined geographical area. The monitored cellular phone can be attached to or carried by a monitored vehicle or a monitored person. For convenience, the invention shall be described in relation to a monitored person. However, it should be understood that the inventive concepts are not limited in this regard.

A control user can choose a predefined geographic area restriction option within a password protected menu setup on the cellular phone. In this way, only the control user can have access to create/modify this option. If desired, the control user can input the start and end time for the period of time during which location monitoring is desired and the frequency of monitoring (to determine how often the location of the device is checked, e.g. in minutes). The control user can also enter data, remotely utilizing cellular communication, or in situ utilizing the keypad or touch screen of the cellular phone, into the monitored cellular phone to provide a definition of the area to which movement of the monitored cellular phone is to be restricted. For example, this definition can be a radial distance from a set location (in feet or meters). Finally, the control user can program the monitored cellular phone to be carried by the monitored user with a target phone number, email address or web PIN. This information can be used for transmitting notifications to a target device concerning a predefined geographic area violation.

The foregoing monitoring parameters can be sent to an application server and the monitoring can start according to the intervals requested by the control user. Each time the location of the cellular phone is requested, it is compared to the predefined geographic area defined by the control user to be sure that the holder of the cellular phone has not violated the boundaries that have been set by the control user. In case of any violation, a message is sent to the control user, and in a preferred non-limiting embodiment to the target device in accordance with the instructions of the control user.

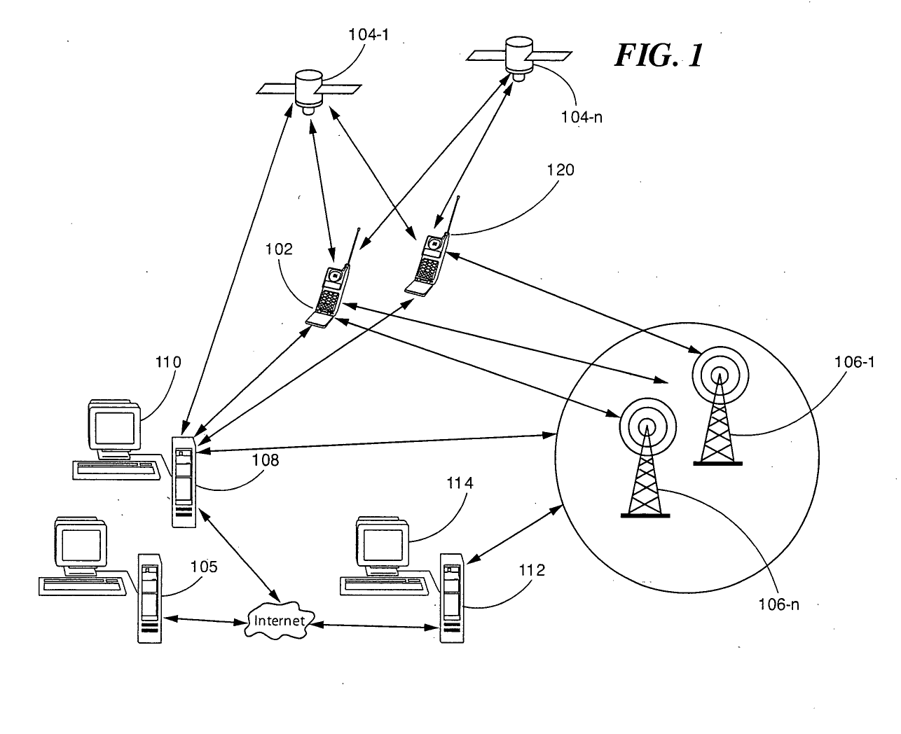

FIG. 1 is a drawing that is useful for understanding the operation of a wireless automatic location identification system in accordance with the inventive arrangements. As illustrated therein, an automatic location identification (ALI) system can rely on a combination of both cellular network based and GPS-based solutions. Such systems collect GPS measurements and network measurements and send the measurement data to the position determination entity. A server 108 can then process the measurements to produce the most accurate location information based on available data.

More particularly, FIG. 1 shows that a conventional network based ALI solution can automatically identify a geographic location of a cellular phone such as a cell phone 102 by way of non-limiting example, by measuring angle of arrival (AOA) and time of arrival (TOA) of cell phone signals at multiple fixed base stations 106-1, 106-n. The cellular phone 102 can be a wireless PDA, cell phone, laptop computer, or any other device incorporating suitable processing and communication circuitry. The fixed base stations 106-1, 106-n can be in communication with a server 108, which can calculate a geographic location of the cellular phone 102. For example, the geographic location can be calculated based on AOA and TOA information.

The server 108 can communicate with the base stations 106-1, 106-n using any suitable means. For example, a conventional telephone network, high-speed data line, wireless link, or a combination of the foregoing can be used. Base stations 106-1, 106-n can provide a data link between the cellular phone 102 and the server 108. The server 108 can be controlled by a workstation 110 or similar user interface device.

Due to the vagaries of signal propagation, base station availability and other infrastructure limitations, the geographic location determined using the network-based solution can be inaccurate in certain instances. In order to improve overall accuracy, the network-based approach can also generate location information for the cellular phone 102 using an alternative approach. For example, the cellular phone can include an onboard global positioning system (GPS) and associated processing circuitry/software. The GPS system can be incorporated into each cellular phone 102 and such system can use signals from a plurality of GPS satellites 104-1, 104-n to independently determine the geographic location of the device. The GPS based location information thus obtained can be forwarded to the server 108 through the one or more base stations 106-1, 106-n. Likewise, server 108 can communicate location information to an emergency or 911 services operator. The ALI data provided by the server can be highly accurate data regarding the location of the cellular phone 102 based on a combination of the network data and GPS data.

Location server 108 is also in communication with an application server 112. Application server 112 processes the location data received from server 108 in accordance with the invention as discussed below. Application server 112 communicates with cellular phones 102, 120 utilizing the cellular network. Server 112 communicates with server 108 by any known communication method, including, but not limited to, Internet, telephone, cellular network, wireless or the like.

It should be noted that servers 108, 112 are utilized in a preferred invention. However, the process discussed below can be performed at a single server. Furthermore, as discussed below, the server may process data stored at the server in response to queries from a cellular phone, or operate on data stored at each cellular phone transmitted with each query. Lastly, it is contemplated that certain cellular phones, communicating with server 108, may have the capacity to operate as server 112.

For the purposes of the present invention, the precise manner by which ALI information is determined is not critical. The system can rely primarily on GPS, network measurements or a combination of the two. Accordingly, the foregoing description represents merely one possible method by which such ALI can be determined. Other methods are also possible and are also intended to be within the scope of the invention.

A database representing a coordinate-based map is stored in a database associated with application server 112 for use thereby. Such maps are known in the art and commercially available from NAVTEQ, MapQuest and others. These maps define locations as geographic coordinates and can be used to graphically represent a position on a map. Furthermore, points of interest with their associated geographical location may be overlaid on the coordinate-based map so that the point of interest, such as a shopping mall, theme park, airport or the like, can be represented as a geographical location having coordinate points.

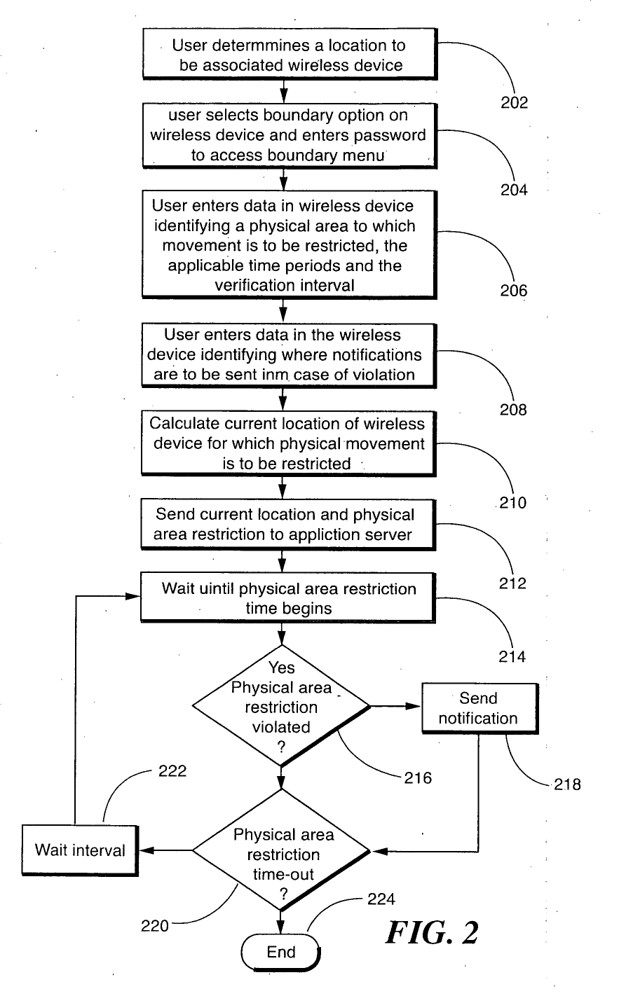

FIG. 2 is a flow chart that is useful for understanding the process of the present invention. The process in FIG. 2 can begin in step 202 when a control determines a geographic location to be associated with the cellular phone. Data identifying one or more geographic locations can be obtained and stored in memory on the cellular phone 102 or at server 112 by any suitable means. For example, one approach would involve physically transporting the cellular phone 102 to the particular location of interest, requesting that the automatic location identification system provide a location report, and then storing that location in a memory, either at cellular phone 102 or application server 112, with a suitable name for later retrieval. Alternatively, a variety of different locations can be provided to cellular phone 102 in the form of a database. The database can be downloaded to the cellular phone for a geographic region and can be stored in memory. Or the database of server 112 may be queried with respect to a point of interest. The location of the point of interest will then be sent to a cellular phone 102 for storage. Regardless of how the location data is obtained, the control user can select a location from the memory of cellular phone 102 or the memory of server 112.

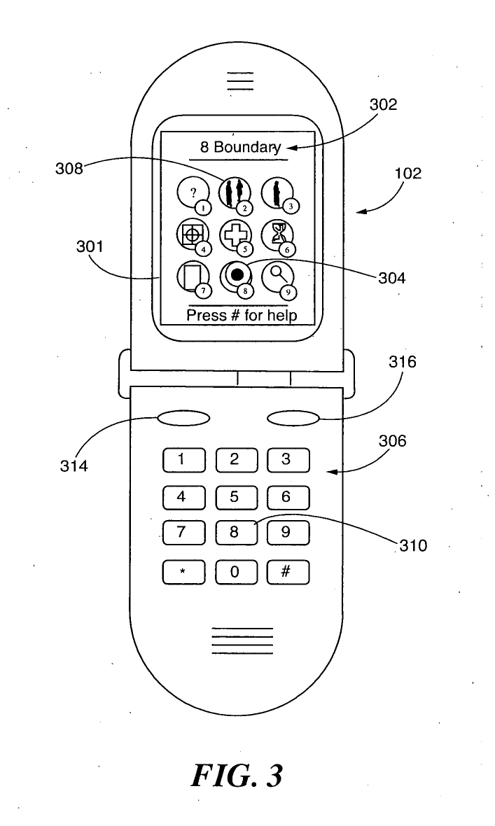

Use of the method is menu driven and in a preferred non-limiting embodiment, menu driven from the screen of a cell phone. FIG. 3 shows cellular phone 102 having a display 301 and a keypad 306 for entering data. A series of icons 304, 308 are presented on the display 301 to identify user options. The display 301 can be a touch screen display, thereby permitting direct activation of associated service by touching each icon on screen. Alternatively, each icon can be identified with a number identifying a corresponding key number corresponding to a key on keypad 306. Pressing the corresponding key can activate the service identified by the associated icon. Step 204 can be performed by entering one or more keystrokes on the keypad 306, or by touching the touch screen display to activate the desired option.

In FIG. 3, the icon 304 represents the “boundary” option and the corresponding key for icon 304 is key number 8, identified here with reference number 310. Thus, in step 202, the user selects the “boundary” option by pressing key number 8. Alternatively, in the case of a touch screen display, the user could tap on the icon 304.

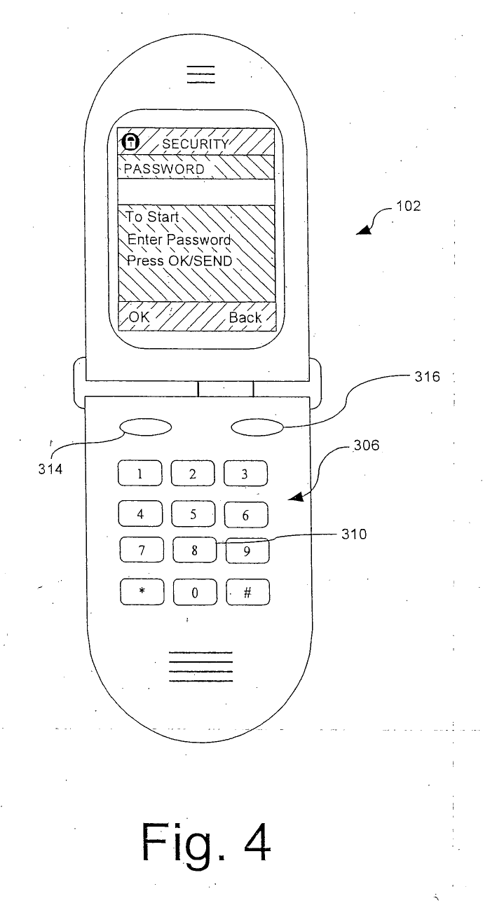

In FIG. 3, the “boundary” option has already been activated as indicated by command line 302. Once the “boundary” option is selected by user input as shown in FIG. 3, a security screen shown in FIG. 4 prompts the user for a password. The password can be known only to the control user and is preferably required for accessing the various menus associated with the boundary option. In this way, a monitored user can be prevented from accessing the boundary menu of a monitored device and can thereby be prevented from disabling the boundary feature.

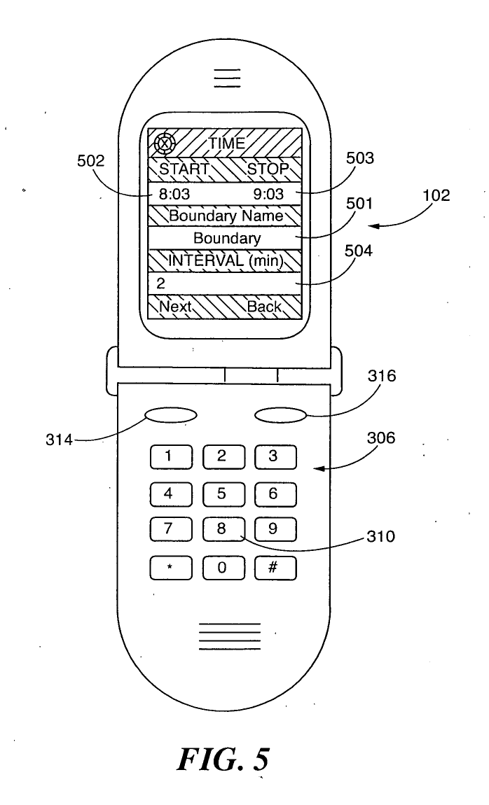

In step 206, the control user can enter data in cellular phone 102 for establishing the boundary parameters. A screen for entering these parameters is shown in FIG. 5. As illustrated therein, the boundary parameters can include identifying a geographic location 501 (in a manner discussed above) relative to which movement of the monitored cellular phone is to be monitored, identifying the times 502, 503 during which such monitoring is to occur, and a verification interval 504, which can control how often the location of cellular phone 102 will be monitored. Additionally, the interval can be set to be repeated on a daily, weekly or monthly basis.

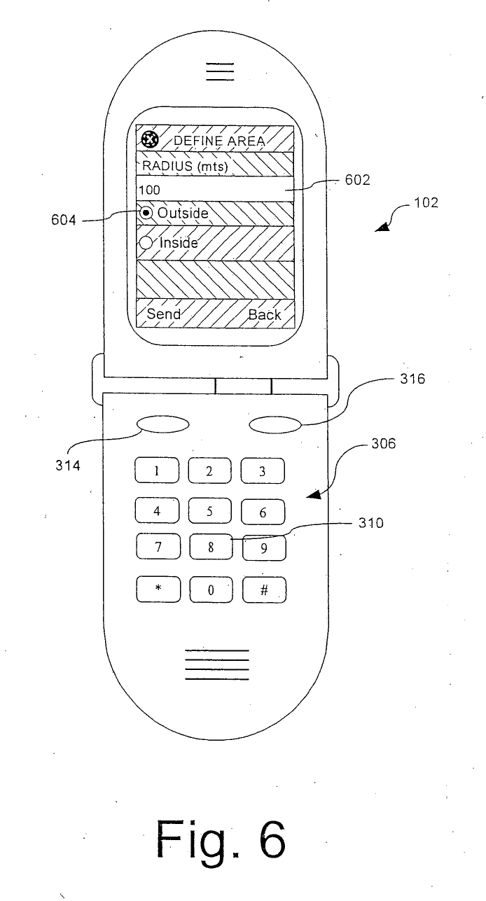

Referring to FIG. 6, the control user can also set a distance relative to the defined location within which the monitored device can be moved without violating a boundary condition. This distance can be variable in different directions so as to define an area of various different geometric shapes by inputting boundary coordinates and storing them. However, a convenient method of establishing the distance is simply to define a radius 602 relative to the geographic location 501. Alternatively, the monitored cellular phone 102 can be excluded from the area defined by the control user. This can be accomplished in FIG. 6 by selecting option 604, which defines the permitted area to reside outside a predetermined radius relative to the geographic location.

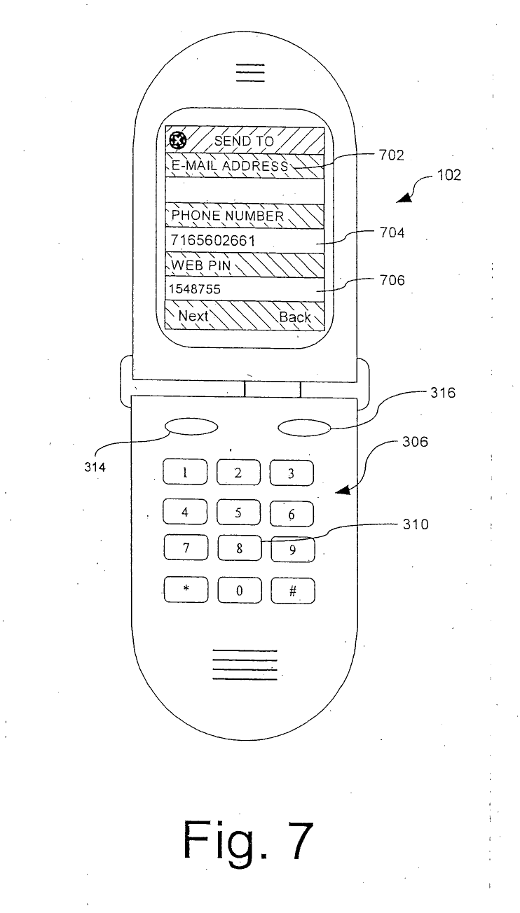

In step 208, the control user can also enter data in the cellular phone identifying where notifications are to be sent in case of a violation of the boundary restrictions entered by the control user. This step is illustrated in FIG. 7, which shows that the control user can select an email address 702, a telephone number 704 of cellular phone 120, or a web PIN number 708 associated with the control user.

Notably, the web PIN number 708 can be used by the control user to access a web-based application that will display the current location of the monitored cellular phone 102. The web-based application can also list any violations of the boundary restrictions established by the control user. Referring to FIG. 1, the web-based application can be accessed by the control user using a personal computer 105 or other Internet device for accessing application server 112 and the associated data via the Internet. The web-based application can be hosted directly by server 108 or can be hosted by any other suitable host computer, such as application server 112, capable of communicating with server 108.

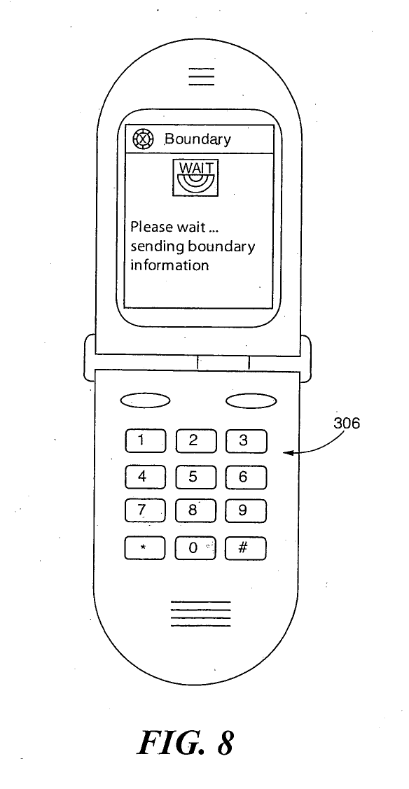

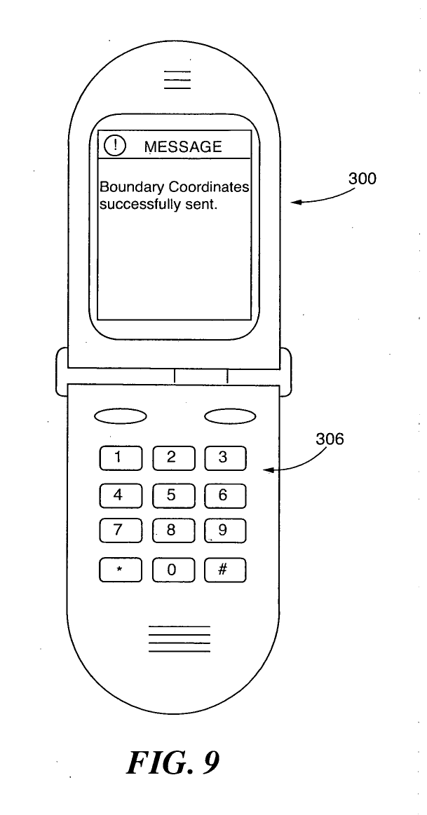

In step 210, the current geographic location of the cellular phone 102 can be calculated. For example, this can be accomplished using commercially available network based and GPS based systems as previously described in relation to FIG. 1. In step 212, the location information thus determined can be communicated from server 108 or from the remote cellular phone 102 to the application server 112. The application server 112 can include at least one user interface 114 for configuring the server and monitoring its operation. During this period of time, a “wait” screen can be displayed as shown in FIG. 8. However, as “bandwidth” increases and microprocessors become faster and more efficient, there may no longer be a real time lapse. After the boundary information has been successfully received by application server 112, it can communicate a notification to cellular phone 102 as shown in FIG. 9.

Referring again to FIG. 2, the process can continue in step 214 with a waiting period. The waiting period may be necessary if the application time interval set by the control user in step 206 has not yet begun. When the system determines that the application time has begun, application server 112 begins checking in step 216 to determine if the predefined geographic area restriction established by the coordinate parameters have been violated. The geographical area of the boundary is compared to the physical location of the cellular phone. Such comparison is performed by cellular phone 102 querying application server 112, or directly by application servers 108 or 112 if all data is stored server side. If the location is inside the boundary (in the outside mode) or outside of the boundary (inside mode), a notification is sent in accordance with the guidelines established by the control user in step 208. The message can be a call to another cellular phone 120, a text message to another cellular phone 120, text or voice message to cellular phone 102, a personal computer such as computer 105, a beeper or a personal data device.

In step 220, the process can continue by checking to determine whether the time interval for boundary has expired. If not, the process can continue in step 222 by entering a wait period corresponding to the duration of a verification interval as established by the control user in step 206. After each verification interval, the process returns to step 214 where the verification step is repeated.

In a preferred embodiment, the control user will be in control of a second cellular phone and be capable of setting boundary violation notification at cellular phone 120. the steps described above would be repeated, and the data associated with the operation could be stored at application server 112 or control cellular phone 102. Furthermore, the control user may arrange for notification of any boundary violation by cellular phone 102 at its cellular phone 120.

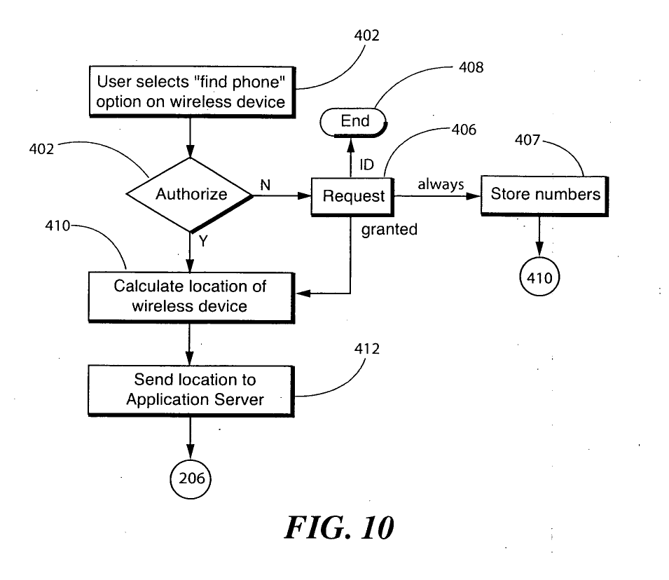

Reference is made to FIG. 10 in which a second embodiment of the invention allowing remote setting of parameters and notification from a second cellular phone 120 is provided. In a step 402, cellular phone 120 indicates, through the use of icons on a display 301 of cellular phone 120, prompts for selecting an option to find another cellular phone. In the preferred embodiment, the icon will prompt the entering of a telephone number corresponding to object cell phone 102. There are often privacy concerns with respect to the identification numbers for the wireless handheld device 120, particularly telephone numbers. Therefore, in an optional step 404-408, an authorization process is performed. However, it is well within the scope of the invention to perform this process without authorization.

In a step 404, server 112 contacts cellular phone 102 and notifies the user by voice mail or text message that a request has been made to subject the object cellular phone 102 to the boundary violation application. This request is preferably made directly to cellular phone 102, but can be communicated through a personal computer 105, traditional telephone, beeper or any other communication means not associated with cellular phone 102.

The user of cellular phone 102 would be prompted to either accept or reject the request. Furthermore, the user of the object cellular phone 102 may be given the option to reject this single request or permanently reject any request from control cellular phone 120. In other words, place a temporary block or permanent block on any such request to avoid repeated messaging of such a request.

In step 404, it is determined whether authority had previously been given to locate the device for the application. If so, the process is passed on to step 410 (FIG. 2). If authorization had not been previously given, then in a step 406 the user of cellular phone 102 can deny the request ending the process in a step 408. The user can always grant the request and the phone numbers of cellular phones 120 and 102 are stored by server 112 to indicate that monitoring shall always be allowed. Lastly, if only a single authorization is provided, then the process is passed to step 410, but no future authorization instruction need be stored by server 112; however, server 112 may store the information for archive purposes.

If the request is denied, then the use of the location and boundary violation application is blocked. However, as discussed above, if the request is granted for a single instance, then the process is passed to step 410. If the request is permanently granted, then the pairing of the control cellular phone identifier and the object cellular phone identifier are stored either at server 112, cellular phone 120, or cellular phone 102. In this way, when step 404 is performed, server 112 will know that authorization has been granted. Once the data has been stored, then the process returns to step 410 as an approved application of the boundary application process.

In step 410, the location of the object cellular phone 102 is automatically calculated. Again, this step can be performed using conventional GPS or network-based techniques or a combination of the two (depending on how accurate determination is provided or needed) as described above relative to FIG. 1. Thereafter, in step 412, the location data is communicated by server 108, or cellular phone 102, to application server 112. Application server 112 can include at least one user interface 114 for configuring the server and monitoring its operation.

The entire process may now return to step 206 of the boundary setting process discussed above in connection with FIG. 2.

By providing a method and system for determining whether a mobile handheld device has crossed a boundary, a control user, such as a parent, may determine whether an object user, such as a child, is in a prescribed location and will be notified if they are not. Furthermore, by setting the activation time, such as during a school day, and a query interval, the whereabouts of the cellular phone and associated child may automatically be monitored. Furthermore, by making a trigger function the crossing of a boundary, it is possible to determine not only whether the object cellular phone leaves a predetermined geographical area, but to set parameters to determine whether the cellular phone has arrived in a prescribed area. For example, if a passenger arrives at an airport and has arranged for limousine service, notification will occur as soon as the cellular phone is turned on upon landing as the cellular phone has entered the bounded area. Similarly, a trucker on a trucking route can automatically notify its dispatcher upon arrival at, or departure from, predetermined stops by presetting several geographical areas of interest; the cellular phone automatically notifying the control device upon leaving or entering the region.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims. For example, instead of the geographical calculation concerning location, boundary violations, and/or map generation being performed at the remote server, one or more of such calculations can be performed directly at the cellular phone.

1. A method for monitoring a location of a cellular phone in relation to a predefined geographic area, comprising the steps of:
selectively identifying a predefined geographic area relative to which movement of said cellular phone is to be restricted;
determining a location of an automatic location identification (ALI) equipped cellular phone; and
comparing said location to said predefined geographic area and determining if said location is within said predefined geographic area; and
sending a notification to a second cellular phone as a result of said determination.

2. The method according to claim 1, further comprising the step of generating a notification if said location is outside said geographic area.

3. The method according to claim 2 further comprising the step of communicating said notification to at least a second cellular phone.

4. The method according to claim 2 further comprising the step of communicating said notification to at least a second cellular phone.

5. The method according to claim 1 wherein said step of identifying said predefined geographic area is further comprised of selecting a geographic location and a maximum permissible distance from said geographic location.

6. The method according to claim 1 wherein said step of determining said location of said ALI equipped cellular phone is performed in response to a request from a remote server.

7. The method according to claim 1 wherein said step of determining said location of said ALI equipped cellular phone is performed in response to a request from a second cellular phone.

8. The method according to claim 1 wherein said step of determining said location of said ALI equipped cellular phone is periodically performed automatically.

9. The method according to claim 1 further comprising the step of integrating at least one security locking system into said cellular phone to prevent unauthorized changes to control settings.

10. The method according to claim 1 wherein said step of automatically determining if said location is within said area is performed by a remote server.

11. The method according to claim 1, further comprising the step of generating a notification if said location is within said area.

12. The method according to claim 1, further comprising the steps of: at least a second person requesting permission to locate said cellular phone, and determining a location of said cellular phone after authorization is granted from said cellular phone.

13. A system for monitoring a location of a cellular phone in relation to a predefined geographic area comprising:
a first automatic location identification equipped cellular phone;
a server, said server in communication with said cellular phone, and determining a geographical location of said cellular phone, said server determining a geographical area; said server comparing said geographical location of said cellular phone and said geographical area and generating a notification as a function of said comparison; and
a second cellular phone in communication with said server and said second cellular phone, said notification being communicated to at least one of said first and second cellular phones.

14. The system of claim 13, wherein said server generates a notification if said geographical location is not within said geographical area.

15. The system of claim 13, wherein said server generates a notification if said geographical location outside said geographical area.

16. The system of claim 13, wherein said second cellular phone communicates with said server to create said geographical area.

17. The system of claim 16, wherein said first cellular phone contacting said second cellular phone if located within said geographical area.

18. The system of claim 13, wherein said second cellular phone communicates with said server to create said geographical area.

19. The system of claim 18, wherein said first cellular phone contacting said second cellular phone if said first cellular phone is outside said geographical area.

20. The system of claim 13, wherein said server periodically determines the location of said first cellular phone.
